(19) United States
(12) Patent Application Publication
(10) Pub. No.: US 2011/0249309 A1
(43) Pub. Date: Oct. 13, 2011

(54) COMPACT HOLOGRAHIC HUMAN-MACHINE INTERFACE

(75) Inventors: R. Douglas McPheters, Stamford, CT (US); Joseph Ciaudelli, Uncasville, CT (US); Thomas J. Cvetkovich, Youngstown, OH (US)

(73) Assignee: HOLOTOUCH, INC., Stamford, CT (US)

(21) Appl. No.: 12/986,843

(22) Filed: Jan. 7, 2011

Related U.S. Application Data
(60) Provisional application No. 61/293,090, filed on Jan. 7, 2010.

(51) Int. Cl. G03H 1/20; G03H 1/22

(52) U.S. Cl. 359/12; 359/32

(57) ABSTRACT

A method of recording an object image of a first hologram as a second hologram is provided. A first hologram is recorded at a first angle of reconstruction and a holographic recording medium is provided. An object beam is directed through the first hologram at the first angle of reconstruction to reconstruct the object image on the recording medium. The recording medium is struck with a reference beam at a second angle of reconstruction to form a wave interference pattern with the object beam. The second angle of reconstruction is between 45 and 90 degrees. The wave interference pattern is recorded. A switch is provided that includes a hologram that has an angle of reconstruction between 45 and 90 degrees. A reproducing light source is positioned to direct light through the hologram at the angle of reconstruction to form a holographic image at a predetermined distance from the hologram. The switch includes a detector that detects the presence of an object proximate to the holographic image. The axis of the detector beam source is not perpendicular to the plane of the medium to which its hologram is affixed.

### CROSS REFERENCE TO RELATED APPLICATIONS

This application claims the benefit of priority under 35 U.S.C. §119(e) to U.S. Provisional Application No. 61/293,090, filed on Jan. 7, 2010, the entire contents of which are incorporated by reference herein.

### BACKGROUND OF THE INVENTION

1. Field of the Invention

The present invention relates to a method and system for creating a holographic image that can be reconstructed by a light source positioned in close proximity to a medium bearing a hologram at an acute angle relative to the plane of the medium, and in particular to angles less than 45 degrees. At least one embodiment of a method and system in accordance with the disclosure are described with reference to the various figures included herein.

2. Description of Related Art

Photo-sensitive media are conventionally used to record a holographic image, such as a letter, a picture, or a symbol. Alternative photo-sensitive media include, but are not limited to, photo-sensitive film and transparent or translucent sheets or plate composed of acrylic or glass and coated with a high-contrast, high-resolution, photo-sensitive emulsion. In addition, holograms can be recorded using surface relief hologram production procedures and techniques.

Reconstructed images of holograms generally become visible when illuminated by a source of light having an “angle of reconstruction”. As is well-known in the art, “angle of reconstruction” refers to the angle between the path of a light beam which illuminates a surface of a medium to which a hologram is affixed and a line which is normal to the surface of that medium. For example, as shown in FIG. 2, the angle of reconstruction θ is the angle between an incident light beam 201 and a line 203 that is normal to the plane of the surface of the medium 202 bearing a hologram 202a. When a reproducing light source 204 illuminates a hologram 202a at the angle of reconstruction θ, a holographic image 205 becomes visible, i.e., is reconstructed, a certain distance 1 from the medium 202 along line 203. As shown in FIG. 2 and as is well-known in the art, the angle of reconstruction θ in conventional holograms is about 45 degrees with the reproducing light source 204 positioned some predetermined distance d from the center of the medium 202 which bears the hologram 202a.

Images of holograms 202a are conventionally reconstructed through use of a reproducing light source 204 located at a sufficient distance d from the medium 202 bearing the hologram which causes reproducing light 201 to be naturally collimated, and causes the resulting holographic image 205 to be sharp, with little or low distortion. For example, as is well-known in the art, using conventional hologram recording and reconstruction techniques, where distance 1 is about 2 inches and angle of reconstruction θ is about 45 degrees, the length of reproducing light path d is about 14 inches. As is also well-known in the art, the length of a reproducing light path d of the hologram 202a cannot be effectively decreased nor the angle of reconstruction θ effectively increased, using conventional hologram recording techniques without sacrificing sharpness of the reconstructed holographic image 205 or introducing distortion. In other words, with respect to conventional arrangements, reducing the length of the reconstructing light path d by moving the reproducing light source 204 closer to the medium 202 to which holograms 202a are affixed increases the likelihood of distorted reconstructed images 205. Moreover, using conventional hologram recording and reconstruction techniques, substantially increasing the reconstruction angle θ, at which the hologram's reproducing light source 204 path strikes the medium 202 bearing the hologram 202a offers potential for distorted reconstructed images 205.

Because of the limitations on the angle of reconstruction θ and the length of the reproducing light path d, conventional recordation and reconstruction of holographic images 205 poses certain problems. For example, the space required to accommodate the angle θ and length of the light path d involved in reconstructing images of conventionally recorded holograms 202a may adversely affect the durability, shape, size or weight of devices making use of those holograms 202a.

Moreover, careful consideration must be given to avoiding optical noise and physical vibration when recording a hologram, since such noise and vibration would tend to distort or destroy the image. Possible vibration-free configurations include using a pulse laser as a light source or affixing all components to a structure isolated from a structure-borne room noise. Using a pulse laser as a light source creates a high energy flash that freezes all microscopic movement. Affixing all components to a structure isolated from structure-borne noise and vibration, for example, can be created in an enclosed room with a vibration-isolated optical table. Holographic plate or film is stored in light-tight boxes until ready for exposure. After exposure, plate and film are processed (typically using chemicals) to develop recorded image(s) and protect them against exposure to normal light levels.

Use of edge-lit holograms to address some of the foregoing problems has been previously investigated, but without being completely satisfactory in resolving practical concerns such as image color, compactness of the reproducing light source path, and the thickness of media bearing edge-lit holograms themselves. (See, e.g., “Edge-Lit Holograms,” Benton, et. al. 1212 Practical Holography IV, 149 (S.P.I.E. 1990)). These factors also adversely affect the durability, shape, size, and weight of other devices intended to make use of holograms, where conventional holograms, and even conventionally recorded edge-lit holograms, would otherwise be employed.

### SUMMARY OF INVENTION

As discussed above, photo-sensitive media are conventionally used to record a holographic image, such as a letter, a picture, or a symbol. Alternative photo-sensitive media include, but are not limited to, photo-sensitive film and transparent or translucent sheets or plate composed of acrylic or glass and coated with a high-contrast, high-resolution, photo-sensitive emulsion. In addition, holograms recorded using the method and system of present invention can be replicated using surface relief hologram production procedures and techniques.

Recording holograms in emulsion affixed to glass or acrylic plate produces copies of holograms that are essentially “one off”. Moreover, recording holograms in emulsion generally offers both inconsistent images and high per unit cost. By contrast, surface relief holograms, which are essentially ridges in the surface of materials, such as polycarbonate, offer the possibility of large volumes of identical copies and very low per unit copy cost. An example of such surface relief holograms are those used in credit cards and driver's licenses, which are actually recorded as transmission holograms.

As will be discussed in greater detail below, to address some of the foregoing concerns a method and system are provided that, in at least one embodiment, mitigate the potential curvature of a reproducing light path d and the distortion of holographic images caused thereby while reducing the reproducing light path such that a reproducing light source can be positioned closer to the medium bearing the hologram as compared to conventional arrangements.

In a first aspect of the invention, a method of recording an object image of a first hologram H1 as a second hologram H2 is provided. In one embodiment, a first hologram H1 is recorded by firing a laser, such as, for example, a Krypton laser with a wavelength of 413 or 448 nm and a HeCd laser with wavelength of 442 nm, as a reproducing light source to make a recording of a hologram. A reference beam strikes a first holographic recording medium for bearing the first hologram H1 directly while an object beam passes through a symbol of the holographic image recorded on master hologram, and then onto the first recording medium, as illustrated in FIG. 3. Once the first medium is exposed, the first hologram is processed and becomes a laser-viewable transmission hologram H1.

As illustrated in FIG. 1, the recorded image on the laser-viewable transmission hologram H1 is reconstructed (becomes visible) when exposed to laser light from the same angle as that to which the reference beam was set during the recording process. The image recorded on the first hologram H1 is reconstructed and transferred to a second holographic recording medium as laser light passes through a spatial filter, collimating optics, and mask, so as to strike a rear surface of the medium bearing the first hologram H1 at the same angle as the reference beam relative to the first medium. Such a step causes a focused image of the recorded symbol in the first hologram H1 to be reconstructed. Concurrently, the same laser light passes through a spatial filter, collimating optics and mask, so as to strike the surface of a second holographic recording medium on which a second hologram H2 is to be recorded at an angle of reconstruction which is measured relative to a line normal to the surface of the second recording medium. The holographic image reconstructed by the first hologram H1 is then recorded as the second hologram H2 on the second holographic recording medium.

Upon recording the second hologram H2, the exposed second holographic medium is processed in a conventional manner. The second hologram H2 can then be used to make hologram copies according to methods well-known in the holographic art. In at least one embodiment, the second hologram H2 can be recorded in photo-resist, producing a surface relief grating which can be subsequently mass-produced using embossing or casting techniques well-known in the holographic art.

Potential curvature of the reproducing light path is avoided by converging or bending together of the wave front of the reference beam through use of a lens that is configured to form curved fringes on the second holographic recording medium such that those fringes are recorded in reverse or conjugate geometry with respect to a diverging or spreading reproducing light source.

Moreover, a method of reconstructing the second hologram recorded is provided. The method includes positioning a reproducing light source proximate to the second holographic medium and illuminating the second hologram at least a substantially increased angle of reconstruction as compared to conventional hologram reconstruction techniques. For example, in one embodiment, the second holographic medium is illuminated at an angle of reconstruction between about 45 and about 90 degrees.

In another aspect of the invention a system for recording an object image of first hologram as a second hologram is provided. The system includes a laser configured to produce a light beam and a first holographic medium containing a recording of a first laser viewable transmission hologram of an object image recorded at a first angle of reconstruction. The system also includes at least one of a first flat mirror, first diverging lens, and a first collimator mirror configured to direct a reproducing beam from the laser to strike the surface of the first holographic medium at the angle of the reference beam used to record the object image. The system further includes a second holographic recording medium configured to contain a recording of a second laser viewable-transmission hologram recorded at a second angle of reconstruction. Further, the system includes at least one of a beam splitter, second flat mirror, third flat mirror, diverging lens, and converging lens configured to direct a reference beam from the laser to strike a surface of the second holographic medium at the second angle of reconstruction, wherein the second angle of reconstruction is substantially increased as compared to conventional hologram reconstruction techniques, and wherein the reconstruction beam and reference beam are configured to concurrently strike the surface of the second holographic medium.

A system for reconstructing the second hologram recorded by the hologram recording system is also provided. The system includes a reproducing light source positioned proximate to the second holographic medium and configured to illuminate the second hologram at an angle of reconstruction which is substantially greater than that obtained using conventional hologram recordation techniques. For example, in one embodiment the angle of reconstruction is between 45 and 90 degrees.

In order to provide a highly compact holographic recording and reproduction system of the present invention with a very wide angle of reconstruction (i.e., greater than 45 degrees), the reconstructing light source can be positioned as close as possible to the plate or film to which the hologram is affixed. In particular in accordance with embodiments of the invention, angles of reconstruction greater than 80 degrees are possible.

Therefore, in another aspect of the invention a compact holographic switch is provided. The switch includes a hologram affixed to a medium, wherein the hologram has an angle of reconstruction greater than 45 degrees. The switch also includes a reproducing light source positioned on one side of the hologram configured to direct light through the hologram at the angle of reconstruction to form a holographic image at a predetermined distance from the hologram on an opposite or same side of the hologram with respect to the reproducing light source. The switch further includes a detector configured to detect presence of an object proximate to the holographic image. The detector is positioned so that the path of its detecting beam intersects the plane of the medium to which the hologram is affixed at an angle that is not normal to that plane in order to avoid the possibility of its beam reflecting directly into itself and distorting its detection capabilities.

Reduced cost and ease of integration of holograms with features of a controlled device can be facilitated through various embodiments of the present invention. Also, the design, manufacture, and engineering of touchless human machine interfaces (HMIs) for electronic and electro-mechanical devices can also be facilitated through various embodiments of the present invention. The present invention is also more efficacious when recording master holograms and minimizes image distortion caused by vibrations or air currents occurring during hologram recording process.

Media to which a hologram may be affixed or which otherwise bear a hologram according to the present invention can be very thin, as compared with more cumbersome and thicker edge-lit holograms taught by the prior art. Depending upon durability concerns related to operation of holographic HMIs and refractive qualities of materials to which holograms may be affixed, those materials may include one of one-quarter inch or greater acrylic plate or glass or other transparent or translucent media. Thinner materials to which holograms may be affixed permit holographic HMIs, for example, to be more compact and lighter than conventional holographic HMIs. Holograms recorded in accordance with the various aspects of the present invention can be reproduced by compact, inexpensive and long-lasting light sources such as LEDs, striking media to which holograms are affixed at large angles of reconstruction, positioned close to media, thereby permitting reduced size and weight of touchless, holographic HMIs. The methods and systems described herein also facilitate creation of colorful holographic images, an essential component of commercial viability of touchless, holographic HMIs.

### BRIEF DESCRIPTION OF THE DRAWINGS

FIG. 1 is a schematic representing an arrangement for recording a hologram in accordance with the present invention.

FIG. 2 is a schematic of conventional positioning of a reproducing light source of a hologram in relation to a medium to which the hologram is affixed.

FIG. 3 is a schematic of an embodiment of a system for recording a hologram in accordance with an aspect of the present invention.

FIG. 4 is an example of a symbol that can be used as a subject of a holographic image.

FIG. 5 is a schematic of another embodiment of a system for reconstructing a holographic image in accordance with an aspect of the present invention.

FIG. 6 shows an embodiment of a two-dimensional image of a three-dimensional hologram of the on/off symbol shown in FIG. 5 and recorded according to an aspect of the present invention.

FIG. 7A is a schematic of an embodiment in accordance with an aspect of the present invention in which reproducing light sources are positioned on a side of a medium to which a hologram is affixed away from the viewer.

FIG. 7B is a schematic of another embodiment in accordance with an aspect of the present invention in which reproducing light sources are positioned on a side of a medium to which a hologram is affixed away from the viewer.

FIG. 7C is a schematic of yet another embodiment in accordance with an aspect of the present invention in which reproducing light sources are positioned on a side of a medium to which a hologram is affixed away from the viewer.

FIG. 8 is an exploded perspective drawing of an exemplary holographic switch assembly configured in accordance with an aspect of the present invention, viewed from a front and a right side.

FIG. 9 is an exploded assembly drawing of the holographic switch assembly shown in FIG. 8, viewed from the front and right side.

FIG. 10 is a cross-sectional view of the holographic switch assembly shown in FIG. 8, taken through plane A-A.

### DESCRIPTION OF PREFERRED EMBODIMENT

According to an aspect of the present invention, a method and system are provided where a holographic image is reconstructed substantially perpendicular to a surface of a medium, such as a plate or film, to which a hologram is affixed while being illuminated by a reproducing light source positioned at an acute or scant angle, for example, of about 12.5 degrees, and less than 45 degrees, with respect to the plane of the medium to which the hologram is affixed, which corresponds to an angle of reconstruction of about 77.5 degrees. In addition, the reproducing light source is positioned very close to the medium to which the hologram is affixed, as compared to conventional hologram reconstruction. In a preferred embodiment, the reproducing light source is positioned about one inch from the center of the medium to which the hologram is affixed.

A holographic image of a hologram recorded in accordance with the present invention is reconstructed when light illuminates the medium to which the hologram is affixed at the same angle of reconstruction used to record the image.

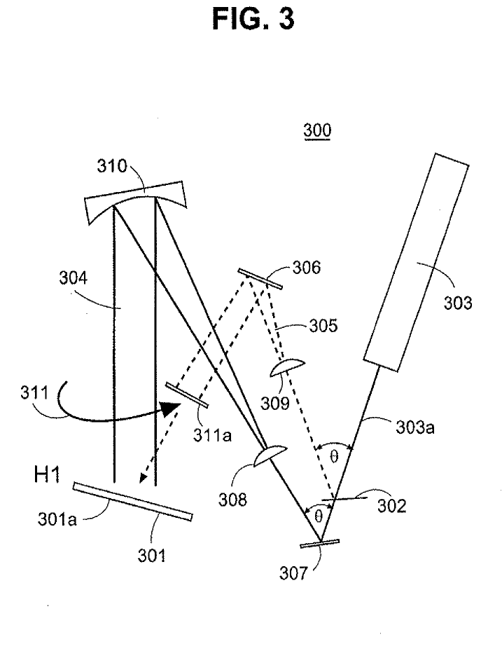

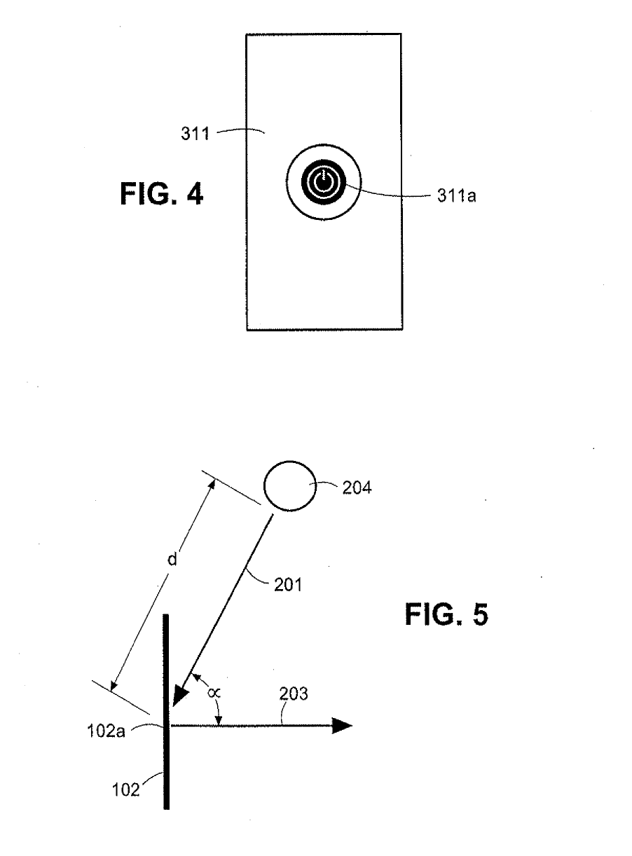

FIG. 3 shows a schematic of a system 300 for recording a hologram H1 on a holographic medium 301, such as a film or plate. The system 300 includes a beam splitter 302 and a laser 303, which together form a laser light beam 303a as two parts or “legs”: namely, a reference beam 304 and an object beam 305. Each leg is redirected by mirrors 307 and 306 respectively and expanded with optics, such as, for example, a spatial filter, shown as diverging lenses 308, 309. The expanded reference beam 304 is collimated using a collimator mirror 310 to limit divergence and create a parallel wave front between the collimator mirror 310 and the medium 301. (It will be understood that the beam splitter 302, mirrors 306 and 307, diverging lenses 308 and 309 comprise a first optical system for manipulating the laser light beam.) The expanded object beam 305 is redirected by mirror 306 through a medium 311 bearing a symbol or representation of the image to be recorded, and then onto the holographic medium 301. The image intended to form a subject of the hologram H1, for example the international “On/Off” symbol shown in FIG. 4, is composed on a suitable medium 311, such as black transfer vinyl adhered to a diffusion screen, which can be, for example, a plate of ground glass. Alternately, the image intended to form the subject of the hologram H1 can be affixed to medium 311 formed as a high-contrast photographic plate such as Kodak® 1A (Eastman Kodak Co., Rochester, N.Y.). The reference beam 304 and object beam 305 meet at the holographic medium 301 and create a wave interference pattern that, when recorded on the medium 301 as hologram H1, records an amplitude and a phase of the reconstructed holographic image. This type of hologram (H1) is sometimes referred to in the art as a “shadow gram.” The reference beam 304 and the object beam 305 are configured to have the same path length to the holographic medium 301, but differ in power by up to a 20-to-1 ratio, and preferably a 3-to-1 ratio. Polarization of the laser light 303a can be preserved by keeping the angle θ between incident beam 303a and the respective reflected beams 304, 305 perpendicular at each mirror 306, 307 (though not shown to scale in FIG. 3)

The hologram H1 affixed to medium 301 can be used as a master to produce copies of the hologram H1. As described above with respect to the system 300 shown in FIG. 3, a first hologram H1 is recorded first, and a second hologram H2 is then recorded using the first hologram H1 as its master. Once the first master hologram H1 is processed, it becomes a laser-viewable hologram so that, when exposed to laser light of the same wavelength, from the rear and at the same angle as the reference beam 304 employed in recording the first hologram H1, its image becomes visible and is reconstructed and transferred to a second master hologram H2, in the manner shown in FIG. 3

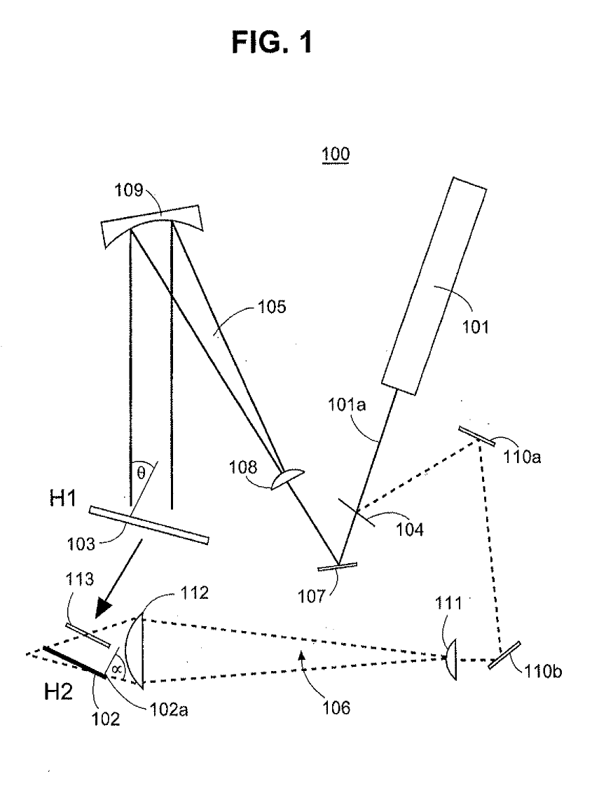

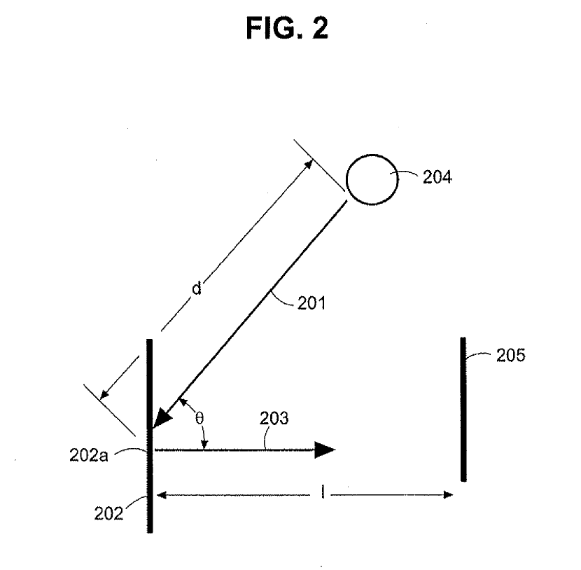

Another embodiment of a system for recording a hologram on a medium is shown in FIG. 1. The system 100 includes a laser 101, such as a Krypton laser with a wavelength of 413 or 448 nm or HeCd laser with wavelength of 442 nm, which is fired to record a hologram H2 by exposing a holographic medium 102, such as a photosensitive film or plate. The system 100 uses a laser viewable transmission hologram H1 recorded on a first holographic medium 103. The first hologram H1 can, for example, be recorded using the system 300 shown in FIG. 3 and described above. The recorded image of the first hologram H1 is reconstructed, so that is it becomes visible, when it is exposed to laser light from the same angle as the reference beam (e.g., 304, FIG. 3) was set during the recording process. The system 100, also includes a beam splitter 104 that is configured to split a laser beam 101a into a reconstruction beam 105 for reconstructing the first hologram H1 and a reference beam 106 for recording the second hologram H2. The reconstruction beam 105 is redirected by a flat mirror 107 and is expanded by a spatial filter 108, such as a lens. The expanded reconstruction beam 105 is then collimated by a collimator mirror 109 to create a parallel wave front moving toward the first hologram H1. (It will be understood that the beam splitter 104, mirror 107, spatial filter 108 and collimator mirror 109 comprise a second optical system.) The real image 113 of symbol or other artwork recorded on the first hologram H1 is reconstructed between the first holographic medium 103 and the second holographic medium 102. Concurrently, the reference beam 106 for the second hologram H2 is redirected by other mirrors 110a and 110b and passes through another spatial filter, such as a diverging lens 111 and a converging lens 112, before striking the surface of the second holographic medium 102 at a second angle of reconstruction a that is greater than 45 degrees. The beams of light issuing from the first holographic medium 103 and the converging lens 112 meet at the surface of the second holographic medium 102. The image 113 reconstructed by the first hologram H1 is then recorded on the second holographic medium 102 as a second hologram H2. Afterwards, the exposed second holographic medium 102 is processed in a conventional manner. The second hologram H2 can then be used to make hologram copies according to conventional methods. For adaptation to this application, the hologram H2 can also be recorded in photo-resist, producing a surface relief grating which can be subsequently mass-produced using embossing or casting techniques well-known in the art. By virtue of the arrangement of the system 100, the angle of reconstruction a of the second hologram H2 can be made larger than the conventional 45 degree angle of reconstruction shown in FIG. 2.

As shown in FIG. 5, by way of comparison to the conventional arrangement shown in FIG. 2, the larger angle of reconstruction a permits the reconstructing light source 204 to be positioned relatively close to the surface of the second holographic medium 102 and at a complementary scant angle (i.e., less than 45 degrees) with respect to the surface of the second holographic medium 102. In practice such an arrangement facilitates decreasing the size of a system for reconstructing the holographic image of H2.

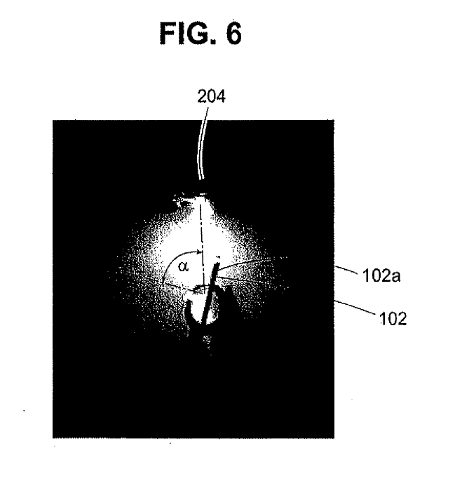

FIG. 6 shows a photograph of an arrangement in accordance with the schematic shown in FIG. 5 in which the hologram has the object image of the on/off symbol shown in FIG. 4. As shown, the angle of reconstruction is larger than 45 degrees.

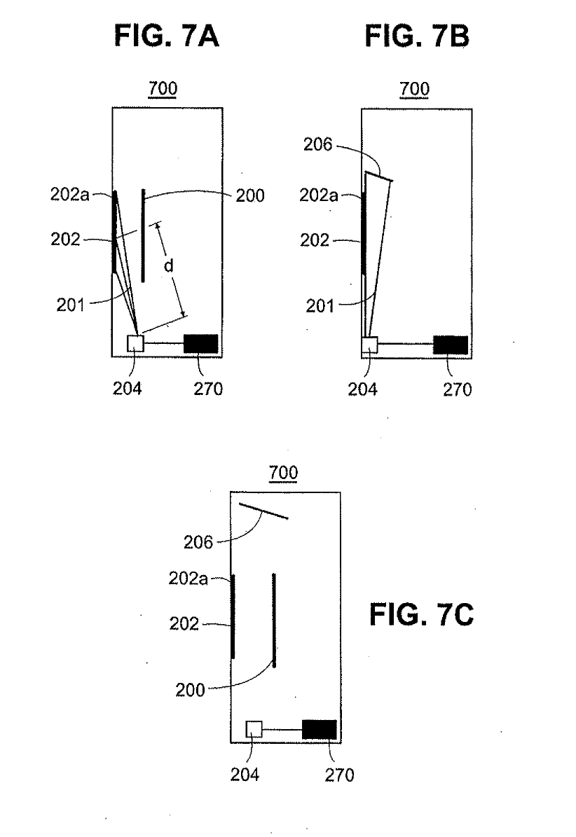

FIGS. 7A-7C show three embodiments of systems 700 for reconstructing a hologram 202a recorded having a large angle of reconstruction, preferably larger than 45 degrees, and more preferably, larger than 75 degrees, and most preferably larger than 80 degrees. In the three embodiments of systems 700 a reproducing light source 204 is positioned proximate to the holographic medium 202 bearing the hologram 202a. In the embodiments shown in FIGS. 7A-7C the light source 204 is a light emitting diode (LED) 204, although other light sources may be used as will be appreciated by one of skill in the art. The light source 204 can be powered by a suitable electric power supply 270, which can include an AC or DC electric power supply. The reconstructed holographic image (not shown) is reconstructed substantially perpendicular (e.g., within about 15 degrees) to the surface of the holographic medium 202 bearing the hologram 202a.

As shown in FIG. 7A, the reproducing light source 204 is positioned a certain distance d away from the center of the surface of the holographic medium 202 bearing the hologram 202a and illuminates the surface of the medium 202 (and the hologram 202a) at an angle of reconstruction that is greater than 45 degrees. The angle of the light beam 201 with respect to the surface of the holographic medium 202 is an acute angle that is preferably less than 45 degrees, and is more preferably about 12.5 degrees, such that the angle of reconstruction is preferably greater than 45 degrees, and is more preferably about 77.5 degrees. A baffle 200 is included in the system 700 to further direct light projecting from the reproducing light source 204 as well as to at least partially shield from the view of operators some areas of system 700 positioned on a side of the holographic medium 202 opposite the operator.

As shown in FIG. 7B, reproducing light source 204 is positioned substantially coplanar with the surface of the holographic medium 202 bearing the hologram 202a. A prism 206, having a mirrored surface facing the reproducing light source 204 and the holographic medium 202, is positioned above the holographic medium 202. The reproducing light source 204 projects light toward the prism 206, which is configured to redirect the light toward the surface of the holographic medium 202 (and the hologram 202a) at the angle of reconstruction α. The angle of the incident light beam from reproducing light source 204 with respect to the surface of the holographic medium 202 is an acute angle, which is preferably less than 45 degrees, and is more preferably about 12.5 degrees, corresponding to an angle of reconstruction a of about 77.5 degrees. A baffle 200, such as that shown in FIG. 7A, may be optionally included in the system 700 to further direct light issuing from reproducing light source 204.

As shown in FIG. 7C, reproducing light source 204 is positioned between the surface of the holographic medium 202 bearing hologram 202a and a baffle 200, and a prism 206 having a mirrored reproducing light source-facing surface is positioned above the holographic medium 202 and the baffle 200. Light projecting from reproducing light source 204 is directed by the holographic medium 202 and the baffle 200 toward the prism 206, whereupon it is redirected toward the surface of the holographic medium 202 (and the hologram 202a) at the angle of reconstruction α. The angle of the incident light beam with respect to the surface of the holographic medium 202 is an acute angle, which is preferably less than 45 degrees, and is more preferably about 12.5 degrees, in which case the angle of reconstruction is about 77.5 degrees. A baffle 200 is included in the system to further direct light issuing from reproducing light source 204.

By virtue of the three embodiments of systems 700 shown in FIGS. 7A-7C, for example, as compared to conventional systems, the size and weight of materials used to arrange components to reconstruct images of a hologram can be reduced by increasing the angle of reconstruction in design, engineering, and manufacture of touchless, holographic HMIs for electronic and electro-mechanical devices. In one embodiment, the reproducing light source can be positioned near the medium to which the hologram is affixed, either on a side of the medium facing the viewer or on a side of the medium facing away from the viewer.

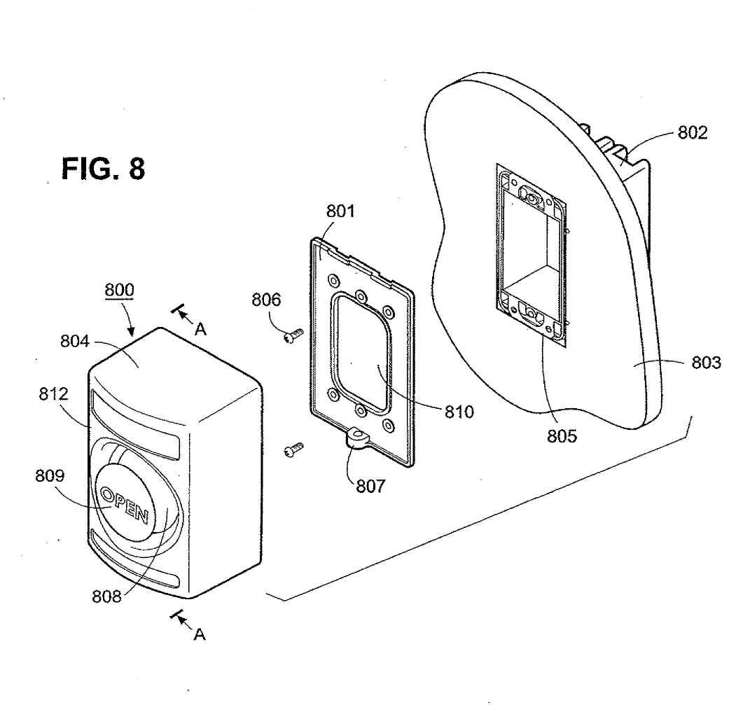

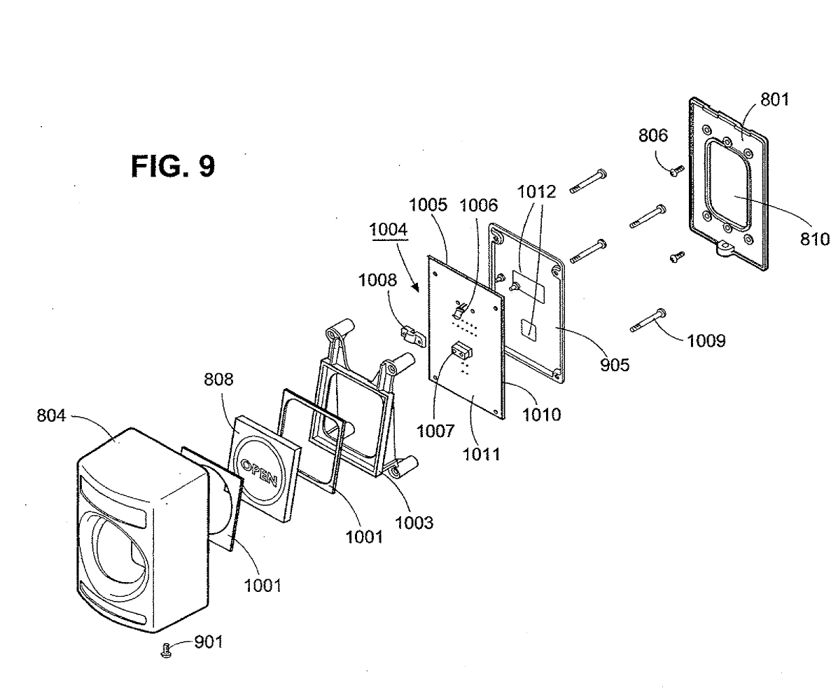

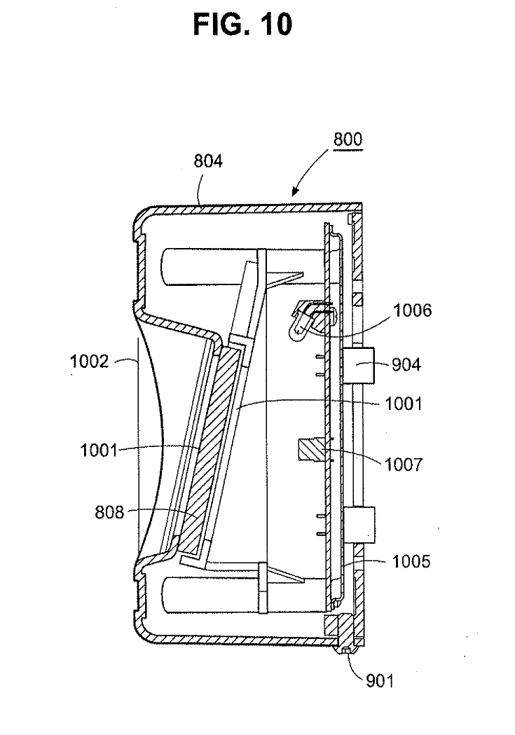

FIG. 8 is an exploded perspective drawing of an exemplary holographic switch assembly 800, constructed in accordance with the principles of the present invention, as viewed from a front and right side. The switch 800 displays a holographic image 809 of a hologram 808 proximate to a front surface 812 of a bezel 804. As shown in FIG. 8, the reconstructed holographic image 809 displaying the word “OPEN” is projected in front of the hologram 808 a predetermined distance, which can be at a location that is near the front surface 812 of the bezel 804. The switch 800 is actuated or switched by placing an object, such as a finger of an operator, at or through the reconstructed holographic image 809. A beam from a detector 1007, shown in FIGS. 9 and 10, strikes the hologram 808 at an angle that is other than normal to the plane of the hologram 808, and detects the presence of such an object and transmits a signal to actuate the switch 800. For example, in one embodiment of the detector 1007, the beam from the detector 1007 can strike the hologram at an angle of up to 20 degrees with respect to a line normal to the plane of the hologram 808. By virtue of its features, an operator can operate the switch 800 without contacting or depressing a physical button.

The holographic switch assembly 800 is configured to be used in conjunction with a mounting plate 801 and wiring receptacle 802 disposed behind the surface of a wall 803. The switch assembly 800 is comprised of the bezel 804, at least partially surrounding other portions of the switch assembly 800 as discussed below. The mounting plate 801 is configured to attach to the wiring receptacle 802 at a front opening 805 of the wiring receptacle 802 near the surface of the wall 803, and can be fastened with various types of fasteners, such as screws 806. The mounting plate 801 has a substantially rectangular opening 810 therethrough that has dimensions that are within the maximum wiring envelope defined by ANSI/NEMA WD 6-2002 (page 15). The bezel 804 can be secured to the mounting plate 801, such as with a fastener, such as a screw 901, shown in FIG. 9, that can be threaded into a mating connection 807 to secure the bezel 804 to the mounting plate 801.

FIG. 9 is an exploded perspective drawing of the holographic switch assembly 800 and mounting plate 801 of FIG. 8, showing further details of other components enclosed in the bezel 804 which are not shown in FIG. 8. The bezel 804 encloses the hologram 808, which is sandwiched between two gaskets 1001. For simplicity of illustration the hologram 808 and a medium on which the hologram is disposed are shown as being integral; however, as will be appreciated, the hologram 808 and a medium bearing the hologram may be separate elements. In one embodiment, the hologram 808 can be formed as a surface relief hologram as follows: a transmission hologram is recorded according to the various embodiments of the methods described herein with an angle of reconstruction greater than 45 degrees, and is rendered into a surface relief hologram sandwiched between plates of clear polycarbonate. Such a surface relief hologram generally has higher image fidelity and much lower cost than transmission holograms and emulsion-based holograms. The hologram 808 and gaskets 1001 are disposed between the bezel 804 and a hologram mounting bracket 1003. The hologram mounting bracket 1003 is configured to position the hologram 808 at an angle less than 45 degrees relative to a vertical plane. In one embodiment the hologram 808 is positioned at an angle of 12.5 degrees with respect to the vertical plane. A printed circuit board assembly 1004, along with a printed circuit board shield 905, are disposed on another side of the hologram mounting bracket 1003, opposite the hologram 808. The printed circuit board assembly 1004 includes a printed circuit board 1005, a light emitting diode (LED) 1006 connected to the circuit board, the detector 1007, and at least one input/output connector 904 (FIG. 10) in electrical communication with at least one of the LED 1006 and the detector 1007. The LED 1006 and the detector 1007 are positioned facing the rear side of the hologram 808, while the input/output connectors 904 are disposed on a rear side 1010 of the printed circuit board 1005 facing the circuit board shield 905. The LED 1006 is disposed with a holder 1008, fastened to the printed circuit board 1005, on a front side 1011 of the printed circuit board 1005. In one embodiment, the LED 1006, detector 1007, and a signal processing integrated circuit are formed as an integral unit and disposed on the printed circuit board 1005. For example, in one embodiment, a Sharp Model GP2Y0D805Z0F photodiode-based detector, manufactured by Sharp Optoelectronics Group (Sharp Microelectronics of the Americas) is used as the detector 1007, with a signal processing integrated circuit. Fasteners 1009, such as screws, secure the gaskets 1001, hologram 808, hologram mounting bracket 1003, printed circuit board assembly 1004, and the circuit board shield 905 to the bezel 804 to form the holographic switch assembly 800. In one embodiment, the holographic switch assembly 808 has overall dimensions of about 3.2 inches wide, 4.8 inches tall, and 1.7 inches deep (measured front to rear).

FIG. 10 is a sectional view of the holographic switch assembly 800 shown in FIG. 8, through plane A-A, which is at the horizontal midpoint of the front of the switch assembly 800. The switch assembly 800 is shown in an assembled condition. As shown in the example embodiment of FIG. 10, the LED 1006 is angled about 30 degrees with respect to the plane of the printed circuit board 1005 and is disposed about 1.4 inches above the detector 1007 and about 1.4 inches vertically from the center of the hologram 808. The detector 1007 can include at least one photo-diode. The detector 1007 is substantially horizontally aligned with the center of the hologram 808; its detecting beam passes through hologram 808 at an angle measured between the line of its beam and the plane of the hologram 808 of about 70 degrees. The detector 1007 is positioned so that the path of its detecting beam intersects the plane of the medium to which the hologram 808 is affixed at an angle that is not perpendicular to that plane in order to avoid the possibility of its beam reflecting directly into itself and distorting the detection capabilities of the detector 1007.

The LED 1006 and the detector 1007 both face a rear side of the hologram 808. As discussed earlier, the hologram 808 is disposed at an angle of about 12.5 degrees with respect to the surface of the printed circuit board 1005, which lies in a vertical plane. The hologram 808 shown in FIG. 16 is configured to have an angle of reconstruction of about 78 degrees. In operation, light from the LED 1006 passes through the hologram 808 at an angle of reconstruction of 70 degrees to reconstruct the holographic image 809 in front of the hologram 808 at a distance of about 50 mm in front of the detector 1007, as indicated by line 1002. In one embodiment, the detector 1007 is configured to sense the presence of an object proximate the location defined by the holographic image 809. The detector 1007 can sense the presence of an object approximately 50 mm from the detector 1007. The sensing of the presence of an object, such as a finger, in the region defined by the holographic image 809 at, for example, the 50 mm location, can, in one embodiment, be converted to an electronic signal and transmitted through the input/output connector 904 of the holographic switch 800.

While the present invention has been described with respect to what are presently considered to be the preferred embodiments, the invention is not limited to those embodiments. Rather, the present invention covers various modifications and equivalent arrangements included within the spirit and scope of the appended claims. The scope of the appended claims is to be accorded the broadest interpretation so as to encompass all such modifications and equivalent structures and functions.

What is claimed is:

1. A method of recording an object image of first hologram as a second hologram, comprising the steps of:
recording a first laser transmission hologram of an object image onto a first holographic medium at a first angle of reconstruction;
reconstructing the object image by passing a reconstruction beam of the laser light through a first optical system through a surface of the first holographic medium at the first angle of reconstruction toward a second holographic medium;
transferring the object image by passing a reference beam of the laser light through a second optical system to strike a surface of the second holographic medium at an acute angle of reconstruction; and
recording the reconstructed object image on the second holographic medium as a second hologram when the reconstruction beam and the reference beam concurrently strike and expose the second holographic medium.

2. The method according to claim 1, wherein the object image is reconstructed substantially co-planar with respect to the second holographic medium.

3. The method according to claim 1, wherein the step of recording a first hologram includes exposing a photosensitive film or plate.

4. The method according to claim 1, wherein the step of recording the reconstructed object image on the second holographic medium includes at least one of (a) exposing a photosensitive film, (b) exposing a photosensitive plate and (c) recording in photo-resist.

5. The method according to claim 1, wherein the step of transferring the object image includes converging the laser light through a converging lens immediately before the second holographic medium.

6. The method according to claim 5, wherein the step of recording the reconstructed object image includes recording curved fringes on the second hologram in reverse or conjugate geometry.

7. The method according to claim 1, wherein the second angle of reconstruction is greater than about 45 degrees and less than about 90 degrees.

8. A method of reconstructing the second hologram recorded according to claim 1, including:
positioning a reproducing light source proximate to the second holographic medium; and
illuminating the second hologram at least an angle of reconstruction greater than about 45 degrees and less than about 90 degrees.

9. The method according to claim 8, wherein the second hologram is reconstructed substantially perpendicular to the surface of the second holographic medium.

10. The method according to claim 1, wherein said reconstructing step is performed by the first optical system, which comprises at least one of a spatial filter, collimating optics and a mask.

11. The method according to claim 1, wherein said transferring step is performed by the second optical system, which comprises at least one of a spatial filter, collimating optics, and a mask.

12. A system for recording an object image of first hologram as a second hologram, comprising:
a laser configured to produce a light beam;
a first holographic medium containing a recording of a first laser viewable transmission hologram of an object image recorded at a first angle of reconstruction;
a first optical system configured to direct a reconstruction beam from the laser to strike the surface of the first holographic medium at the first angle of reconstruction to reconstruct the object image;
a second holographic medium configured to contain a recording of a second laser viewable transmission hologram recorded at a second angle of reconstruction; and
a second optical system configured to direct a reference beam from the laser to strike a surface of the second holographic medium at the second angle of reconstruction, wherein the second angle of reconstruction is greater than about 45 degrees and less than about 90 degrees, and wherein the reconstruction beam and reference beam are configured to concurrently strike the surface of the second holographic medium.

13. The system according to claim 12, wherein the object image is reconstructed substantially co-planar with respect to the second holographic medium.

14. The system according to claim 12, wherein the first holographic medium and second holographic medium include at least one of (a) a photosensitive film, (b) a photosensitive plate, and (c) a photo-resist.

15. The system according to claim 12, wherein said second optical system comprises a converging lens.

16. The system according to claim 15, wherein the converging lens is positioned in a light path between the laser and the second holographic medium, the converging lens being positioned in the light path immediately preceding the second holographic medium.

17. The system according to claim 16, wherein the converging lens is configured to record curved fringes of the object image on second holographic medium in reverse or conjugate geometry.

18. A system for reconstructing the second hologram recorded by the system of claim 12, including:
a reproducing light source positioned proximate to the second holographic medium configured to illuminate the second hologram at least an angle of reconstruction greater than about 45 degrees and less than about 90 degrees.

19. The system according to claim 18, wherein the reproduction light source is configured to reconstruct the second hologram substantially perpendicular to the surface of the second holographic medium.

20. The system according to claim 12, wherein said first optical system comprises at least one of a mirror, a diverging lens, and collimator optics.

21. The system according to claim 12, wherein said second optical system comprises at least one of a bean splitter, a mirror, a diverging lens, and a converging lens.

22. A compact holographic switch comprising:
a hologram affixed to a medium, wherein the hologram has an angle of reconstruction greater than 45 degrees and less than 90 degrees;
a reproducing light source positioned on one side of the hologram configured to direct light through the hologram at the angle of reconstruction to form a holographic image at a predetermined distance from the hologram on an opposite side of the hologram from the reproducing light source; and
a detector configured to detect presence of an object proximate to the holographic image.

23. The switch according to claim 22, further comprising a detector positioned so that the axis of its beam source is not perpendicular to the plane of the medium to which its hologram is affixed.

24. The switch according to claim 22, further comprising a printed circuit board, wherein the reproducing light source and the detector are connected to the printed circuit board.

25. The switch according to claim 22, wherein the reproducing light source is a light emitting diode.

26. The switch according to claim 22, wherein the angle of reconstruction is about 78 degrees.

27. The switch according to claim 22, wherein the holographic image is reproduced at about 50 mm from the detector.

28. The switch according to claim 22, wherein the detector is configured to actuate the switch upon a detection of the presence of the object.

29. The switch according to claim 22, wherein the detector includes at least one photo-diode.

30. The switch according to claim 29, wherein the detector is configured to receive light from the object reflected when the object is proximate to the holographic image.

31. The switch according to claim 23, wherein the axis of the beam source is directed at an angle of up to 20 degrees with respect to a line that is perpendicular to the plane of the medium bearing the hologram.

32. A method of reproducing a holographic image comprising:
providing a hologram recorded with an angle of reconstruction greater than about 45 degrees and less than about 90 degrees; and
directing light toward the hologram at the angle of reconstruction.

33. The method according to claim 32, wherein directing includes
providing a light source configured to direct light of the same wavelength used to record the hologram; and
projecting light from the light source at the same wavelength used to record the hologram.

34. The method according to claim 33, further including positioning the light source a fixed distance from the hologram.

35. The method according to claim 34, further including providing a baffle, and positioning the light source between the hologram and the baffle.

36. The method according to claim 34, further including
providing a prism and positioning the prism between the hologram and the light source; and
redirecting at the prism light received from the light source toward the hologram.

37. The method according to claim 36, wherein the light source is positioned substantially coplanar with the hologram.

38. The method according to claim 36, further including providing a baffle and positioning the baffle between the prism and the light source.

39. A method of recording an object image of a first hologram as a second hologram, comprising the steps of:
providing a first hologram recorded at a first angle of reconstruction;
providing a holographic recording medium;
directing an object beam through a surface of the first hologram at the first angle of reconstruction to reconstruct the object image on the holographic recording medium;
striking the holographic recording medium with a reference beam at a second angle of reconstruction to form a wave interference pattern with the object beam,
wherein the second angle of reconstruction is greater than about 45 degrees and less than about 90 degrees; and
recording the wave interference pattern on the holographic recording medium.

40. A system for reconstructing a hologram including:
a hologram affixed to a medium, wherein the hologram has an angle of reconstruction greater than about 45 degrees and less than about 90 degrees;
a reproducing light source positioned on one side of the hologram configured to direct light through the hologram at the angle of reconstruction to form a holographic image at a predetermined distance from the hologram on an opposite side of the hologram from the reproducing light source; and

41. The system according to claim 40, wherein the reproducing light source is configured to direct light of the same wavelength used to record the hologram.

42. The system according to claim 41, wherein the reproducing light source is positioned a fixed distance from the hologram.

43. The system according to claim 42, further including a baffle, wherein the reproducing light source is positioned between the hologram and the baffle.

44. The system according to claim 43, further including a prism positioned between the hologram and the reproducing light source, wherein the prism is configured to redirect light received from the light source toward the hologram.

45. The system according to claim 44, wherein the light source is positioned substantially coplanar with the hologram.
